(19) United States
(12) Patent Application Publication
(10) Pub. No.: US 2007/0280701 A1
(43) Pub. Date: Dec. 6, 2007

(54) Method and Apparatus for Producing High Extinction Ratio Data Modulation Formats

(75) Inventor: Richard Oberland, Romford (GB)

Correspondence Address: WORKMAN NYDEGGER, 60 EAST SOUTH TEMPLE, 1000 EAGLE GATE TOWER, SALT LAKE CITY, UT, 84111, US

(73) Assignee: AZEA NETWORKS LIMITED, Romford, Essex (GB)

(21) Appl. No.: 11/569,553

(22) PCT Filed: May 24, 2005
(86) PCT No.: PCT/GB05/02049

§ 371 Date: Aug. 20, 2007

(30) Foreign Application Priority Data
May 25, 2004 (GB) 0411684.4
Jan. 10, 2005 (GB) 0500398.3

(51) Int. Cl. H04B 10/18

(52) U.S. Cl. 398/192

(57) ABSTRACT

The present invention provides both a method and an apparatus for optically encoding data. Light from a coherent source is split into two separate light signals, and each of these light signals is modulated with the data such that the data levels output correspond to the points of maximum optical power. One of the modulated light signals is phase biased to be in phase or in anti-phase with the other modulated light signal and the two light signals are then combined to form a combined optical output. The present invention enables the resulting combined optical output to be a data format with a high extinction ratio compared with conventional optical data formats. It can be used to produce a wide variety of optical data modulation formats.

### FIELD OF THE INVENTION

The invention relates to optical data formats for optical data transmission, and in particular to data formats with a high extinction ratio.

### BACKGROUND TO THE INVENTION

Optical data transmission is widely used for long haul, short haul, and metro network based systems. Typically, optical data is provided by electrically modulating light from a coherent light source, using an electro-optic modulator. High performance electro-optic modulators are usually based on a Mach-Zehnder (MZ) interferometer structure.

Most long distance networks are impaired by the loss of the optical transmission fibre. The loss is usually overcome by the use of optical amplifiers. These amplifiers provide signal gain but also produce optical noise known as Amplified Spontaneous Emission (ASE). The optical noise mixes with the optical signal at the receiver photodiode, producing electrical beat noise. This noise usually dominates the receiver's Optical Signal to Noise Ratio (OSNR) versus Bit Error Ratio (BER) performance. The OSNR performance can be improved by reducing the beat noise on the ‘0’ level bits by reducing the light level sent on ‘0’ bits.

The transmitter performance is determined by the ratio of optical power in the ‘1’s to the optical power in the ‘0’s and is called extinction ratio. A high extinction ratio signal is achieved by driving the modulator such that the ‘0’ power level is minimised. However light in the ‘0’s is unavoidable due to the noisy electrical drive signal being converted into optical noise at the modulation stage.

One might expect the extinction ratio of the data signals to be significantly improved by connecting multiple modulators in series and applying in time the same modulation signal to each modulator. When using MZ modulators in the usual way, the noise on electrical drive signals is converted in a linear manner with random 180 degree phase discontinuities on the ‘0’ light level. When applied to subsequent MZ modulators the discontinuities cause both constructive and deconstructive interference to occur leading to a smaller improvement in extinction ratio than expected.

The aim of the present invention is to provide a system and method for producing optical data signals with an improved extinction ratio over existing data formats.

### SUMMARY OF THE INVENTION

According to a first aspect of the present invention, a method of optically encoding data, comprises the steps of:

splitting light from a coherent light source into first and second light signals;

modulating the first light signal with the data using a first optical intensity modulator;

modulating the second light signal with the data using a second optical intensity modulator; and,

coupling the light output from the first and second optical intensity modulators to obtain a combined optical output,

wherein the first and second optical intensity modulators are biased and driven such that the data logic levels output correspond to the points of maximum optical power,

and wherein the output of one of the first and second optical modulators is phase biased to be either in phase or in anti-phase with the output of the other of the first and second optical modulators, such that the combined optical output gives rise to the maximum optical extinction ratio.

The optical modulation method of the present invention gives rise to a data format with a high extinction ratio compared with conventional optical data formats. The combination of the electric field transfer function of each of the modulators and the power transfer function of the modulator superstructure means that the zero power level is compressed, mitigating the effect of noise in the electrical data signals. A further advantage of the present invention is that it may be used to obtain a wide variety of optical data modulation formats.

Preferably, the first and second modulators are electro-optic modulators. More preferably, they are Mach-Zehnder modulators.

Preferably, the optical modulators are driven with RZ data. Electrical RZ drivers typically give rise to less noise than electrical NRZ drivers. Nevertheless, the optical modulators may also be driven with NRZ data.

Preferably, a delay is applied to the data driving one of the first and second optical modulators. More preferably, the magnitude of this delay is any one of: 0 bits; 1 bit; or, any value between 0 bits and 1 bit. The ability to apply such a delay allows a the selection of a variety different data modulation formats.

In some embodiments of the present invention, the logical polarity of the data driving one of the first and second modulators is inverted. This feature allows the selection of further data modulation formats.

According to a second aspect of the present invention, an optical transmitter for transmitting optically encoded data comprising a coherent light source and a modulator structure, the modulator structure including:

an optical splitter coupled to the coherent light source for splitting light from the coherent light source into first and second light signals;

a first optical intensity modulator for modulating the first light signal with data;

a second optical intensity modulator for modulating the second light signal with data;

means for phase biasing the output of one of the first and optical modulators to be either in phase or in anti-phase with the output of the other of the first and second optical modulators, such that the combined optical output gives rise to the maximum optical extinction ratio; and,

a coupler for coupling the output from the first optical intensity modulator and the output from the second optical intensity modulator,

wherein the first and second optical intensity modulators are adapted to be biased and driven such that the data logic levels out correspond to the points of maximum optical power.

Preferably, the transmitter is integrated onto a single substrate. Alternatively, it may be in the form of a plurality of discrete components. It is preferred to use a single substrate so as to eliminate variations in temperature and stress sensitivity between elements of the transmitter.

Preferably, the transmitter further includes electrical RZ drivers connected to each of the first and second optical modulators. Alternatively, the transmitter may include electrical NRZ drivers connected to each of the first and second optical modulators.

### BRIEF DESCRIPTION OF THE DRAWINGS

Examples of the present invention will now be described in detail with reference to accompanying drawings, in which:

FIG. 1 illustrates the electrical field function and corresponding optical power transfer function versus drive voltage for a typical x-cut zero-chirp Lithium Niobate Mach Zehnder modulator;

FIG. 2 illustrates the optical modulator structure of a transmitter in accordance with the present invention;

FIG. 3 illustrates the electrical field function and corresponding optical power transfer function versus vector sum of the combining fields for the optical modulator structure of FIG. 2;

FIG. 4 illustrates the drive and bias conditions for the inner modulators in accordance with one example of the invention;

FIG. 5 shows the pulse shape of a phase encoded duo-binary optical signal generated in accordance with the present invention.

FIG. 6 is a table indicating the conditions under which a number of different modulation formats are obtainable using an optical modulator in accordance with the present invention;

FIG. 7 illustrates possible drive signals and the resulting modulator output to obtain a duobinary RZ modulation format; and,

FIG. 8 illustrates schematically a transmitter architecture in accordance with the present invention.

### DETAILED DESCRIPTION

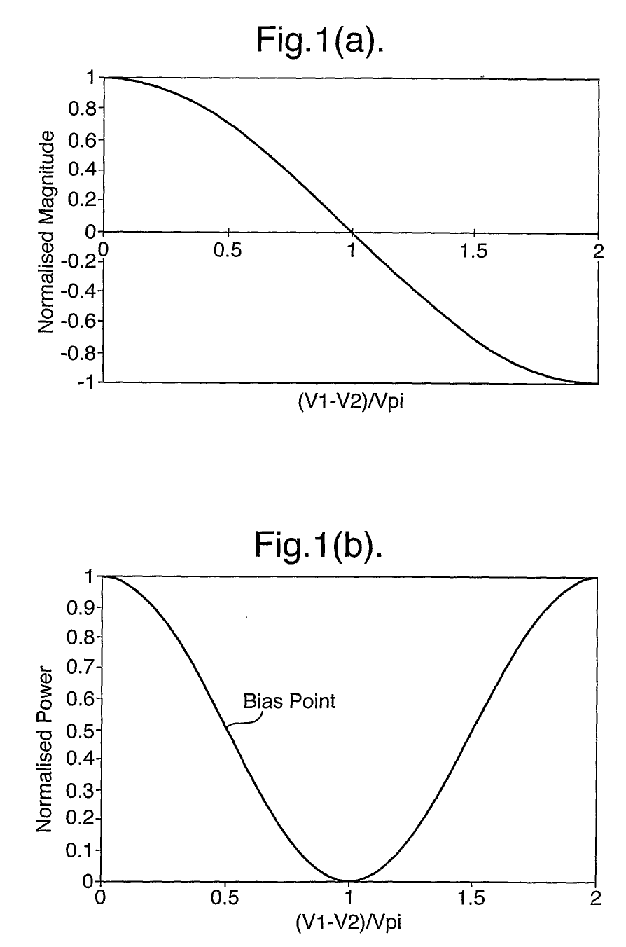

FIG. 1a illustrates the electrical field transfer function of a typical x-cut zero-chirp Lithium Niobate Mach-Zehnder (MZ) modulator. The applied voltage is shown on the x-axis as a normalised difference between the voltage applied to the two arms of the modulator, and the resultant electrical field output is shown as a normalised value on the y-axis. The x-axis is divided into units of V1-V2/Vpi, where V1 is the voltage applied to a first arm of the modulator, V2 is the voltage applied to the other arm of the modulator and Vpi is the voltage difference between V1 and V2 required to give rise to a phase shift of 180° i.e. destructive interference at the output and hence zero electric field. The units of the y-axis are normalised by the maximum electric field at the output.

FIG. 1b shows the power transfer function corresponding to the square of the electrical field transfer function of FIG. 1a. The typical constant bias point about which the modulator is driven is indicated in FIG. 1b. The bias point is the half power point or quadrature point.

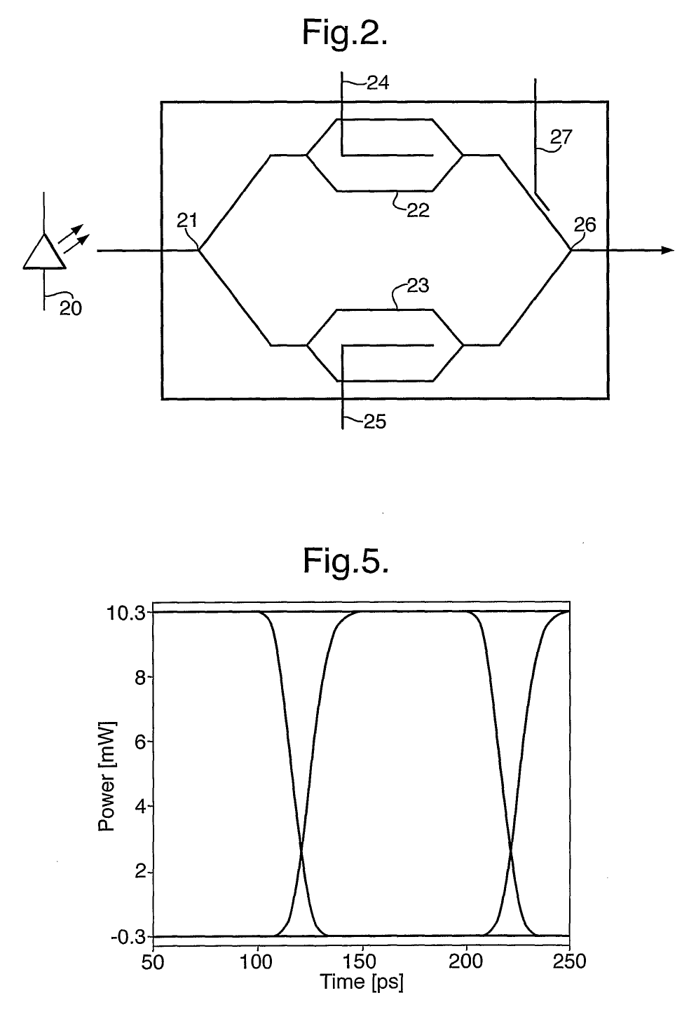

The present invention uses an MZ super-structure as shown in FIG. 2. The MZ super-structure comprises two MZ modulators connected in parallel. The input of the MZ super-structure comprises a Y splitter. Coupled to each output of the Y splitter is an MZ modulator. The outputs of the MZ modulators are coupled together at a super-structure output. One arm of the super-structure output may be DC biased to change the phase of the light.

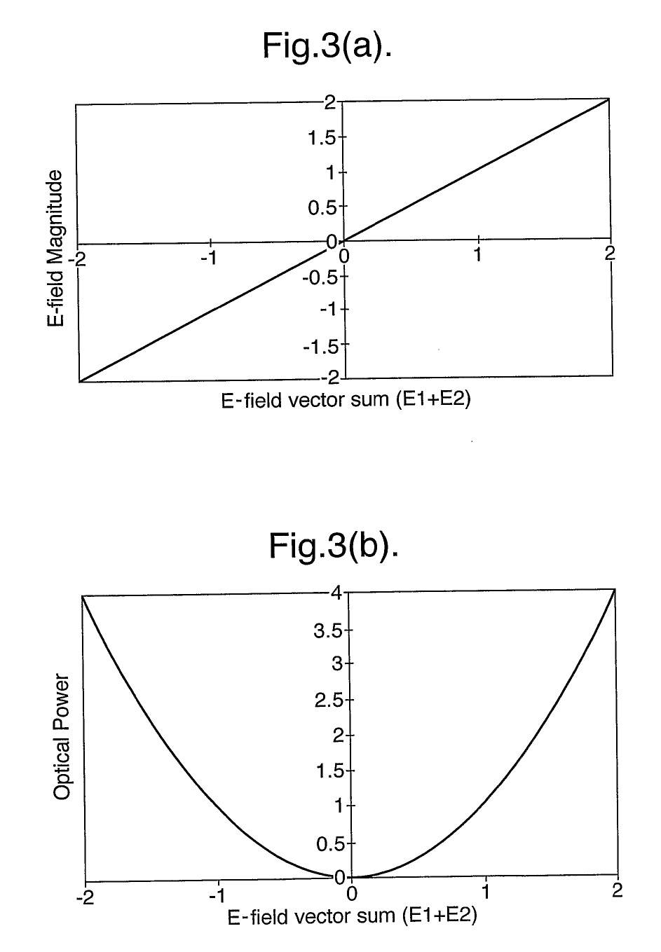

The optical electric field transfer function for the super-structure is shown in FIG. 3a as the magnitude of the electric field versus the vector sum of the electric field from each of the MZ modulators. The corresponding optical power transfer function is shown in FIG. 3b. The optical power transfer function of the MZ super-structure is a parabola.

Each of the modulators has the electric field transfer function shown in FIG. 1a with field compression occurring at the corresponding maximum power points. This, coupled with the parabolic power transfer function of the superstructure means that around the ‘0’ output power level, the total transfer function is compressed as compared with a single MZ modulator i.e. a change in the applied voltage leads to a relatively small change in optical output power.

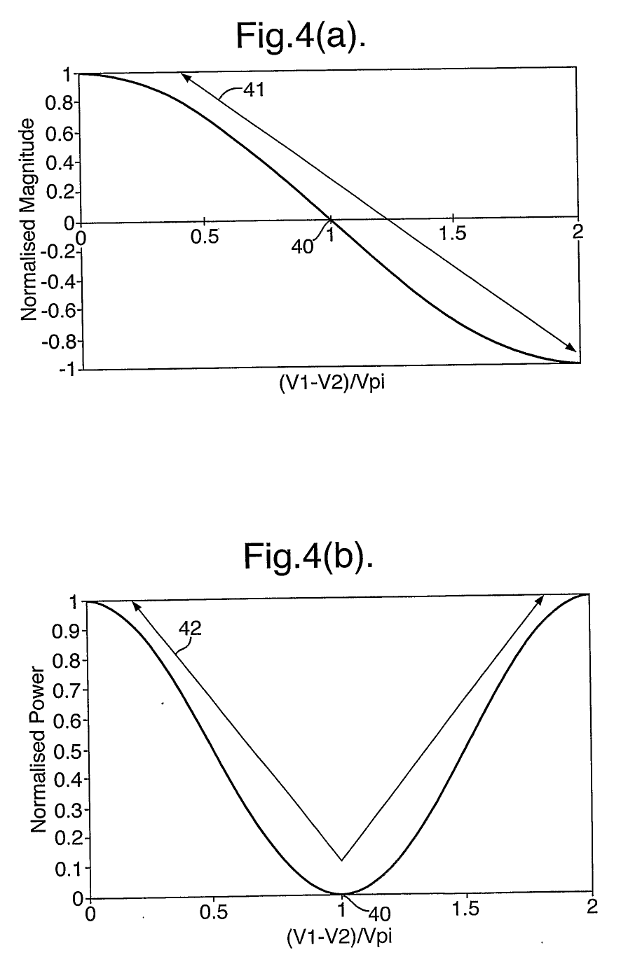

By driving one or both of the inner modulators with a 2Vpi peak-to-peak signal about the null point, the shape of the optical pulses produced by the superstructure are modified as compared to conventional optical data pulses. The drive and bias conditions are illustrated in FIG. 4. FIG. 4a shows the electrical field transfer function as in FIG. 1a and FIG. 4b the power transfer function of the inner modulators. The null point 40 is indicated as the point of zero electrical field or optical power and the extent of the drive signals is indicated by the arrows 41 and 42. The pulses have a low crossover point indicating ‘0’ level compression, as shown in the eye diagram of FIG. 5. Electrical noise at points where there should be zero optical power output is compressed. This produces signals with a higher extinction ratio and hence a better receiver optical OSNR performance, highly desirable in optical data transmission.

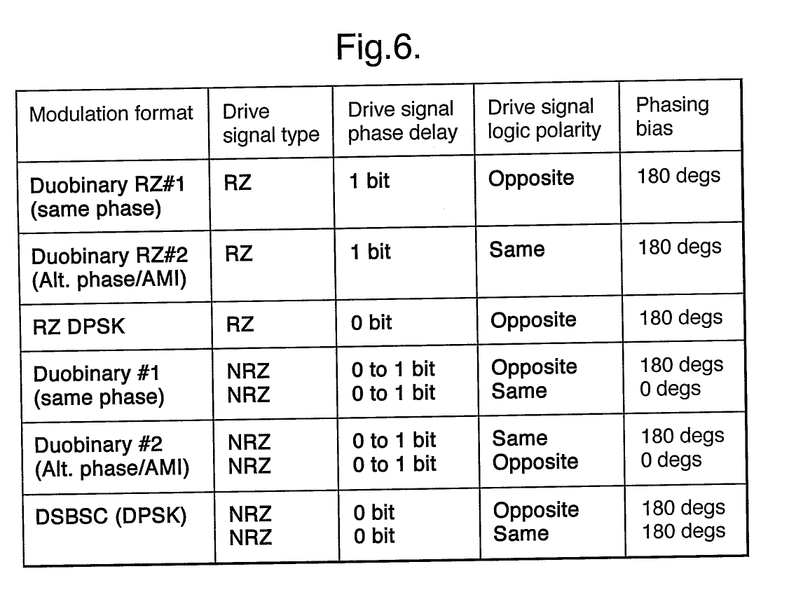

Driving both MZs in a superstructure as shown in FIG. 2 with 2Vpi about the null point can produce a number of different modulation data formats as shown in FIG. 6. In particular, the present invention provides effective means for producing duobinary data formats. These have narrower spectral widths than binary data and are increasingly being used in wavelength division multiplexed (WDM) data transmission.

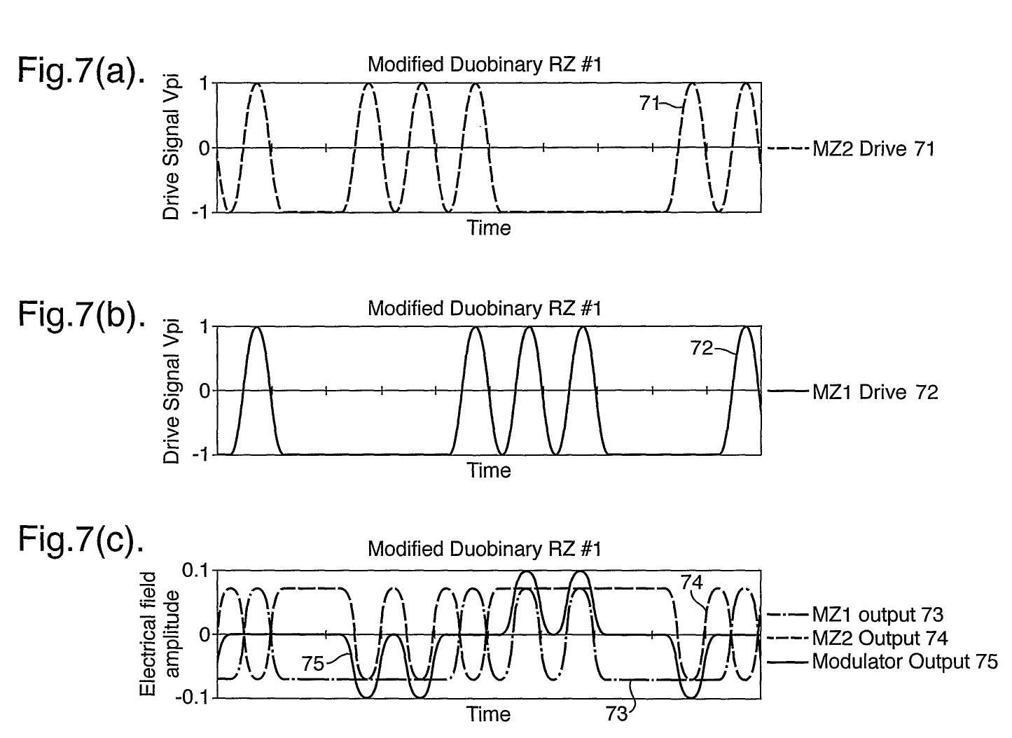

FIG. 7 shows a particular example of a duobinary format (labelled as duobinary RZ#1 in FIG. 6). A first drive signal 71 is applied to the first and MZ and has opposite logical polarity to a second drive signal 72 applied to the second MZ, the logical polarity of the second drive signal 72 having been inverted. Furthermore, the second drive signal 72 is delayed by 1 bit relative to the first drive signal 71. The outputs (73 and 74) of the two MZs are shown in FIG. 7c along with the resulting combined modulator output 75. As can be seen in FIG. 7c, the output 74 of the second MZ is phase inverted. This is as a result of setting the phasing bias to 180°. In this way the logical ‘0’s of the modulator output are obtained through the combination of equal and opposite resulting electric field amplitudes from each MZ, and not through a zero amplitude output from either MZ (as is typical of the prior art). This is possible since the modulators are driven 2Vpi around the null point rather than 1Vpi with the null point at an extreme. As described above, combining the two MZ outputs leads to compression of the ‘0’ output power level and therefore an improved extinction ratio. The improvement in OSNR performance due to the present invention when using RZ data is of the order of 0.5 dB/nm relative to typical prior art devices.

In this case the duobinary format has a constant phase between ‘1’ bits not divided by a ‘0’. If the drive signal logic polarity is the same for each modulator then it is possible to create a modified duobinary format (labelled ‘Duobinary RZ#2’ in FIG. 6) where there is an alternate phase between each ‘1’ bit. This is known as Alternate Mark Inversion (AMI).

Duobinary optical data can also be obtained using NRZ drive signals. As shown in FIG. 6, a delay of up to one bit may be used between the data applied to each modulator and the same or opposite polarity data can be used for each modulator.

All On-Off-Keyed (OOK) formats benefit from the cascaded MZ transfer functions and offer high extinction ratios. It is possible to generate Phase-Shift-Keyed (PSK) formats with this method and apparatus. The ability to select a wide range of modulation formats is very useful from a system perspective.

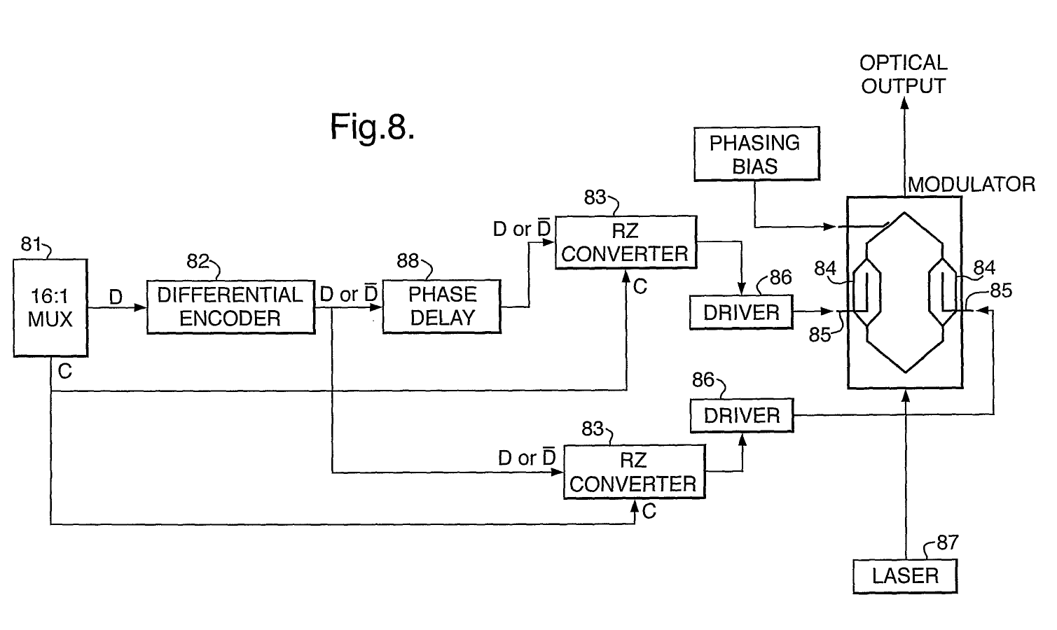

FIG. 8 shows an example of a transmitter architecture in accordance with the present invention. Synchronous electrical data and clock is provided from a 16:1 multiplexer chip that interfaces from SDH or Forward Error Correction (FEC) circuitry 81. The data is differentially encoded by differential encoder 82 required for duo-binary formats. The output data polarity can be of either sense depending on the format required, labelled as data or data bar. The data or inverted logic data is converted to an RZ form using the RZ converters 83. The RZ converters are high-speed logical AND gates, requiring synchronous data and clock inputs. Suitable chip based differential encoders and RZ converters are available from Inphi Corporation. An optical modulator superstructure is as shown in FIG. 2, with MZ modulators 84 connected in parallel, each having an electrode 85 driven by an RZ driver 86. A suitable modulator structure is available from Sumitomo Osaka Cement and is their SSB modulator. The optical modulator superstructure is shown coupled to a laser light source 87. The transmitter shown is set up to use RZ drivers. Suitable RZ drivers are available from LA techniques. NRZ data and drivers may be used and the need for RZ converters is then eliminated, however, RZ data is generally preferred as RZ drivers have superior performance to NRZ drivers. The electrical data applied to one electrode may be delayed relative to the other using a phase delay means 88, such as is available from Iterra Communications. The phase delay typically provides a 0 or 1 bit data delay between the RZ data streams. For NRZ data the delay can be up to 1 bit and determines for optical pulse width.

As shown, a DC phasing bias may be applied to the output of one of the modulators in the optical modulator structure. This phasing bias provides a constant phase shift to the light in one arm. The phase shift is chosen to be 0 or 180° relative to the other arm and dependent on the data format required. The two combining arms then interfere either in phase or in anti-phase.

As described above, the data logic applied to one modulator may be the same as or inverted relative to the data applied to the other modulator. Using a delay and/or different data for each arm leads to different output optical data formats which may be selected to suit a particular application. Applying data to one arm and a constant bias to the other leads to other high extinction ratio formats.

1-27. (canceled)

28. A method of optically encoding binary data, comprising the steps of:
splitting light from a coherent light source into first and second light signals;
modulating the first light signal with the binary data using a first optical intensity modulator;
modulating the second light signal with the binary data using a second optical intensity modulator; and
coupling the light output from the first and second optical intensity modulators to obtain a combined optical output,
wherein the first and second optical intensity modulators are driven at points of maximum optical transmission,
and wherein the output of one of the first and second optical modulators is phase biased to be either in phase or in anti-phase with the output of the other of the first and second optical modulators, such that the combined optical output gives rise to a maximum optical extinction ratio.

29. The method according to claim 28, wherein the first and second modulators are electro-optic modulators.

30. The method according to claim 28, wherein the first and second modulators are Mach-Zehnder modulators.

31. The method according to claim 28, wherein the first and second optical modulators are driven with RZ or NRZ data.

32. The method according to claim 28, wherein a delay is applied to data driving one of the first and second optical modulators.

33. The method according to claim 32, wherein the magnitude of the delay applied to one of the first and second modulators is any one of: 0 bits; 1 bit; or, any value between 0 and 1 bits.

34. The method according to claim 33, further comprising the steps of:
driving the first and second optical modulators by RZ data;
applying a delay of 1 bit to the data driving one of the first and second optical modulators; and
phase biasing the output of one of the first and second optical modulators to be in anti-phase with the other of the first and second light signals,
wherein the combined optical output is a duobinary RZ format in which consecutive logical “1”s have opposite phase.

35. The method according to claim 33, further comprising the steps of:
driving the first and second optical modulators by NRZ data;
applying a delay of between 0 bits and 1 bit to the data driving one of the first and second optical modulators; and
phase biasing the output of one of the first and second optical modulators to be either in anti-phase with the other of the first and second light signals if the logical polarity of the data driving one of the first and second modulators was inverted or in phase otherwise,
wherein the combined optical output is a duobinary NRZ format such that consecutive logical “1”s have the same phase.

36. The method according to claim 33, further comprising the steps of:
driving the first and second optical modulators by NRZ data;
applying a delay of between 0 bits and 1 bit to the data driving one of the first and second optical modulators; and
phase biasing the output of one of the first and second optical modulators to be either in phase with the other of the first and second light signals if the logical polarity of the data driving one of the first and second modulators was inverted or in anti-phase phase otherwise,
wherein the combined optical output is a duobinary NRZ format such that consecutive logical “1”s have opposite phase.

37. The method according to claim 33, further comprising the steps of:
driving the first and second optical modulators by NRZ data;
applying no delay to the data driving either the first or second optical modulators; and
phase biasing the output of one of the first and second optical modulators to be in anti-phase with the other of the first and second light signals,
wherein the combined optical output is a double side band suppressed carrier (differentially phase-shift keyed) format.

38. The method according to claim 28, wherein the logical polarity of the data driving one of the first and second modulators is inverted.

39. The method according to claim 38, further comprising the steps of:
driving the first and second optical modulators with RZ data;
applying a delay of 1 bit to the data driving one of the first and second optical modulators; and
phase biasing the output of one of the first and second optical modulators to be in anti-phase with the other of the first and second light signals,
wherein the combined optical output is a duobinary RZ format in which consecutive logical “1”s have the same phase.

40. The method according to claim 38, further comprising the steps of:
driving the first and second optical modulators by RZ data;
applying no delay to the data driving either the first and second optical modulators; and
phase biasing the output of one of the first and second optical modulators to be in anti-phase with the other of the first and second light signals,
wherein the combined optical output is a differentially phase-shift keyed format.

41. The method according to claim 38, further comprising the steps of:
driving the first and second optical modulators by NRZ data;
applying a delay of between 0 bits and 1 bit to the data driving one of the first and second optical modulators; and
phase biasing the output of one of the first and second optical modulators to be either in anti-phase with the other of the first and second light signals if the logical polarity of the data driving one of the first and second modulators was inverted or in phase otherwise,
wherein the combined optical output is a duobinary NRZ format such that consecutive logical “1”s have the same phase.

42. The method according to claim 38, further comprising the steps of:
driving the first and second optical modulators by NRZ data;
applying a delay of between 0 bits and 1 bit to the data driving one of the first and second optical modulators; and
phase biasing the output of one of the first and second optical modulators to be either in phase with the other of the first and second light signals if the logical polarity of the data driving one of the first and second modulators was inverted or in anti-phase phase otherwise,
wherein the combined optical output is a duobinary NRZ format such that consecutive logical “1”s have opposite phase.

43. An optical transmitter for transmitting optically encoded data comprising a coherent light source and a modulator structure, the modulator structure including:
an optical splitter coupled to the coherent light source for splitting light from the coherent light source into first and second light signals;
a first optical intensity modulator for modulating the first light signal with binary data;
a second optical intensity modulator for modulating the second light signal with binary data;
means for phase biasing the output of one of the first and second optical modulators to be either in phase or in anti-phase with the output of the other of the first and second optical modulators, such that the combined optical output gives rise to a maximum optical extinction ratio; and
a coupler for coupling the output from the first optical intensity modulator and the output from the second optical intensity modulator;
wherein the first and second optical intensity modulators are adapted to be driven at points of maximum optical transmission.

44. The optical transmitter according to claim 43, wherein the first and second optical intensity modulators are electro-optic modulators.

45. The optical transmitter according to claim 44, wherein the first and second modulators are Mach-Zehnder modulators.

46. The optical transmitter according to claim 43, wherein the transmitter is integrated onto a single substrate.

47. The optical transmitter according to claim 43, wherein the transmitter further includes either electrical RZ or NRZ drivers connected to each of the first and second optical modulators.

48. The optical transmitter according to claim 43, wherein the transmitter further includes means to apply a delay to the data driving one of the first and second optical modulators.

49. The optical transmitter according to claim 48, wherein the magnitude of the delay applied to the data driving one of the first and second optical modulators can be any one of: 0 bits; 1 bit; or, any value between 0 bits and 1 bit.

50. The optical transmitter according to claim 49, further comprising:
electrical RZ drivers connected to each of the first and second optical modulators;
means to apply a delay of 1 bit to the data driving one of the first and second optical modulators; and
means for phase biasing the output of one of the first and optical modulators to be in anti-phase with the output of the other of the first and second optical modulators,
wherein the combined optical output is a duobinary RZ format in which consecutive logical “1”s have opposite phase.

51. The optical transmitter according to claim 49, further comprising:
electrical NRZ drivers connected to each of the first and second optical modulators;
means to apply a delay of between 0 bits and 1 bit to the data driving one of the first and second optical modulators; and
means for phase biasing the output of one of the first and second optical modulators to be either in anti-phase with the other of the first and second light signals if the logical polarity of the data driving one of the first and second modulators was inverted, or in phase otherwise,
wherein the combined optical output is a duobinary NRZ format in which consecutive logical “1”s have the same phase.

52. The optical transmitter according to claim 49, further comprising:
electrical NRZ drivers connected to each of the first and second optical modulators;
means to apply a delay of between 0 bits and 1 bit to the data driving one of the first and second optical modulators; and
means for phase biasing the output of one of the first and second optical modulators to be either in phase with the other of the first and second light signals if the logical polarity of the data driving one of the first and second modulators was inverted, or in anti-phase otherwise,
wherein the combined optical output is a duobinary NRZ format in which consecutive logical “1”s have opposite phase.

53. The optical transmitter according to claim 49, further comprising:
electrical NRZ drivers connected to each of the first and second optical modulators;
means to apply a delay of 0 bits to the data driving one of the first and second optical modulators; and
means for phase biasing the output of one of the first and optical modulators to be in anti-phase with the output of the other of the first and second optical modulators,
wherein the combined optical output is a double side band suppressed carrier (differentially phase-shift keyed) format.

54. The optical transmitter according to claim 43, wherein the transmitter further includes means to invert the logical polarity of the data driving at least one of the first and second optical modulators.

55. The optical transmitter according to claim 54, further comprising:
electrical RZ drivers connected to each of the first and second optical modulators;
means to apply a delay of 1 bit to the data driving one of the first and second optical modulators; and
means for phase biasing the output of one of the first and optical modulators to be in anti-phase with the output of the other of the first and second optical modulators,
wherein the combined optical output is a duobinary RZ format in which consecutive logical “1”s have the same phase.

56. The optical transmitter according to claim 54, further comprising:
electrical RZ drivers connected to each of the first and second optical modulators;
means to apply a delay of 0 bits to the data driving either the first and second optical modulators; and
means for phase biasing the output of one of the first and optical modulators to be in anti-phase with the output of the other of the first and second optical modulators,
wherein the combined optical output is a differentially phase-shift keyed RZ format.

57. The optical transmitter according to claim 54, further comprising:
electrical NRZ drivers connected to each of the first and second optical modulators;
means to apply a delay of between 0 bits and 1 bit to the data driving one of the first and second optical modulators; and
means for phase biasing the output of one of the first and second optical modulators to be either in anti-phase with the other of the first and second light signals if the logical polarity of the data driving one of the first and second modulators was inverted, or in phase otherwise,
wherein the combined optical output is a duobinary NRZ format in which consecutive logical “1”s have the same phase.

58. The optical transmitter according to claim 54, further comprising:
electrical NRZ drivers connected to each of the first and second optical modulators;
means to apply a delay of between 0 bits and 1 bit to the data driving one of the first and second optical modulators; and
means for phase biasing the output of one of the first and second optical modulators to be either in phase with the other of the first and second light signals if the logical polarity of the data driving one of the first and second modulators was inverted, or in anti-phase otherwise,
wherein the combined optical output is a duobinary NRZ format in which consecutive logical “1”s have opposite phase.

59. The optical transmitter according to claim 54, further comprising:
electrical NRZ drivers connected to each of the first and second optical modulators;
means to apply a delay of 0 bits to the data driving one of the first and second optical modulators; and
means for phase biasing the output of one of the first and optical modulators to be in anti-phase with the output of the other of the first and second optical modulators,
wherein the combined optical output is a double side band suppressed carrier (differentially phase-shift keyed) format.
